(19) United States
(12) Patent Application Publication
(10) Pub. No.: US 2026/0268674 A1
(43) Pub. Date: Sep. 10, 2026

(54) SYSTEM EMPLOYING AN EVENT CAMERA FOR SYNCHRONIZED RESPONSE TO FAST APPROACHING OBJECTS

(71) Applicant: RAFAEL ADVANCED DEFENSE SYSTEMS LTD., Haifa (IL)

(72) Inventors: Nimrod KRUGER, Haifa (IL); Ami YAACOBI, Haifa (IL)

(21) Appl. No.: 19/162,962

(22) PCT Filed: Mar. 6, 2024
(86) PCT No.: PCT/IB2024/052158

§ 371 Date: Sep. 8, 2025

(30) Foreign Application Priority Data
Mar. 8, 2023 (IL) 301247

(51) Int. Cl. G06V 20/52; F41H 11/02; G01S 17/10; G01S 17/66; G01S 17/88; G06T 7/246; G06V 10/141; G06V 10/147; G06V 10/25; G06V 10/764

(52) U.S. Cl. CPC G06V 20/52; F41H 11/02; G01S 17/10; G01S 17/66; G01S 17/88; G06T 7/248; G06V 10/141; G06V 10/147; G06V 10/25; G06V 10/764

(57) ABSTRACT

A system for synchronizing a response to an approaching object includes an event camera deployed to monitor a field of view, a pulsed active illumination system deployed to deliver pulses of illumination towards at least part of the field of view and a processing system. The processing system monitors events from the event camera to detect a looming object, and then tracks the looming object and processes events associated with the looming object to determine an estimated passing time and passing distance from the event camera. The processing system also receives events from the event camera occurring within a defined period after actuation of a pulse of the illumination towards the looming object and derives from those events a correction to the motion parameters.

### FIELD AND BACKGROUND OF THE INVENTION

The present invention relates to sensors and, in particular, it concerns a system employing an event camera for synchronizing a response to an approaching object.

Dynamic Vision Sensors, also referred to as event cameras, are electrooptic sensors that generates a stream of events, rather than a sequence of images (frame matrix) like a traditional camera. Each reported event represents a change in the intensity of light in a specific pixel, and includes information about the location of the pixel, the time of the event, and the polarity (increase or decrease) of the intensity change. Variations of this technology may include information such as pixel intensity or color information. All such variations are referred to herein generically as “event cameras.”

One of the key advantages of event cameras is that they sense the visual scene at much higher speeds and with lower latency than traditional cameras. They are also considered efficient in terms of power consumption and can be used in challenging lighting conditions.

Most event cameras operate with an asynchronous event stream, meaning event data is reported only when it exists and no data is transmitted from the sensor when no change occurs in the scene. In this scheme, a challenge may rise when trying to utilize the rapid response of a dynamic vision sensor, as the time delay between the physical event and the reported event varies depending on external lighting conditions. This is known as the “latency jitter” and can make it difficult to accurately calibrate the response of a system to fast moving objects.

Sensing of a looming object, i.e., that progressively occupies an increasing area of a field of view, can be used to detect an approaching object. The latency jitter typically gives rise to an uncertainty in precise timing of events of up to a few milliseconds. In low-speed applications, such an uncertainty may not be critical, but in high-speed applications, for example, relating to sensing of an approaching projectile traveling at speeds of hundreds of meters per second, an uncertainty of several milliseconds may critically impair the system's ability to operate precisely-timed countermeasures effectively.

### SUMMARY OF THE INVENTION

The present invention is a system employing an event camera for synchronizing a response to an approaching object.

According to the teachings of an embodiment of the present invention there is provided, a system for synchronizing a response to an approaching object, the system comprising: (a) an event camera deployed to monitor a field of view; (b) a pulsed active illumination system deployed to deliver pulses of illumination towards at least part of the field of view; and (c) a processing system associated with the event camera and the pulsed active illumination system, the processing system including at least one processor, the processing system configured to: (i) monitor events from the event camera to detect a looming object; (ii) track the looming object and process events associated with the looming object to determine motion parameters indicative of an estimated passing time and passing distance from the event camera; (iii) receive events from the event camera occurring within a defined time period after actuation of a pulse of the illumination towards the looming object; and (iv) derive from the events occurring after actuation of the pulse a correction to the motion parameters.

According to a further feature of an embodiment of the present invention, the pulse of illumination is triggered during tracking of a looming object and synchronized as a function of an estimated time until the looming object will leave the event camera field of view.

According to a further feature of an embodiment of the present invention, the pulse of illumination is one of a series of pulses of illumination triggered at a predefined intervals independent of tracking of a looming object.

According to a further feature of an embodiment of the present invention, the pulsed active illumination system is non-illuminating except during the pulses.

According to a further feature of an embodiment of the present invention, the pulsed active illumination system illuminates at least part of the field of view, and wherein the pulses are pulses of darkness during which the illumination is interrupted.

According to a further feature of an embodiment of the present invention, the deriving includes determining from the events occurring after actuation of the pulse a precise position of the looming object at the moment of the pulse, comparing the precise position to a position indicated by the tracking, and providing a correction to the tracking as a result of the comparison.

According to a further feature of an embodiment of the present invention, the correction includes a time offset to compensate for an unknown time delay in events output by the event camera.

According to a further feature of an embodiment of the present invention, the processing system is further configured to: (a) process events associated with the looming object to derive a selective image of the looming object; and (b) apply an image classifier to the selective image in order to determine a type of threat.

According to a further feature of an embodiment of the present invention, the processing system is further configured to output the passing time and the passing distance to an active countermeasures system.

According to a further feature of an embodiment of the present invention, the system is mounted on an intercepting projectile, and wherein the processing system is further configured to output the passing time and the passing distance to a threat-destruction system.

There is also provided according to the teachings of an embodiment of the present invention, a system for synchronizing a response to an approaching object, the system comprising: (a) an event camera deployed to monitor a field of view; and (b) a processing system associated with the event camera and including at least one processor, the processing system configured to: (i) monitor events from the event camera to detect a looming object; (ii) track the looming object and process events associated with the looming object to determine motion parameters indicative of a remaining time to passing and a passing distance from the event camera; (iii) process events associated with the looming object to derive a selective image of the looming object; and (iv) apply an image classifier to the selective image in order to determine a type of threat.

### BRIEF DESCRIPTION OF THE DRAWINGS

The invention is herein described, by way of example only, with reference to the accompanying drawings, wherein:

FIG. 1 is a schematic representation of a use scenario for a system according to an embodiment of the present invention employing an event camera for synchronizing a response to an approaching object;

FIG. 2A is a cloud of events in a scenario of firing of a rocket-propelled grenade viewed from the viewpoint of the camera, where positive events are indicated as blue pixels and negative events are indicated as red pixels;

FIG. 2B is a view of the cloud of events of FIG. 2A displayed isometrically with the vertical axis corresponding to the time of the events;

FIG. 3 is a flowchart illustrating operation of a system for synchronizing a response to an approaching object according to an embodiment of the present invention;

FIG. 4 is a selective image of a looming object derived by grouping events from different times corresponding to the same part of the object according to a motion estimation of the object based on the data of FIGS. 2A and 2B; and

FIG. 5 is a schematic representation of a time-line for the various processes of FIG. 3 in a typical scenario according to certain implementations of the present invention.

### DESCRIPTION OF THE PREFERRED EMBODIMENTS

The present invention is a system employing an event camera for synchronizing a response to an approaching object, and corresponding methods for processing data from an event camera.

The principles and operation of systems and methods according to the present invention may be better understood with reference to the drawings and the accompanying description.

By way of introduction, the present invention relates to detection of looming objects, i.e., approaching objects that progressively occupy an increasing area of a field of view of an electro-optic sensor, in high-speed scenarios. “High-speed scenario” in this context relates primarily to scenarios with relative closing speeds in excess of about 100 m/s (360 km/h), and typically in excess of about 150 m/s. Typical usage scenarios include detecting incoming threats (projectiles) and estimating the time until crossing the camera plane for the purpose of operating active countermeasures, preferably in combination with an estimation of the miss distance and direction, in order to allow precisely-synchronized and correctly-directed operation of active countermeasures. Similar requirements also exist in the case of an intercepting projectile for intercepting an airborne threat, which should similarly estimate the passing time, passing distance and passing direction of the target, at or near the point of closest passing, to enable precise operation of threat-destruction systems. The invention will be described herein by way of example primarily with reference to, and employing terminology suited to, active protection systems for fixed assets and terrestrial vehicles, but should be understood to be applicable also to airborne interceptor scenarios.

Conventional electro-optical imaging systems intended to address such scenarios typically require specialized and expensive high-speed image sensors and powerful data processing hardware, and may require powerful illumination mechanisms with correspondingly-high power consumption. Such implementations typically do not allow for continuous operation of the system for active protection purposes, and therefore require coupling of the electro-optical system to an additional threat detection system that will trigger operation of the electro-optical system. This adds further to the system cost and complexity, and may limit response times, performance and flexibility when tackling various scenarios.

In contrast, a threat detection system according to the teachings of certain embodiments of the present invention takes advantage of the high-speed sensing and low data volume of an event camera to detect looming objects in high-speed scenarios, without a heavy computational load and with low power consumption.

Such high-speed usage scenarios present unique challenges for an event camera-based system. Firstly, as mentioned above, latency jitter results in an uncertainty about the true time of an event sensed by the event camera, typically giving rise to an unknown offset that may be in the range of 0-3 milliseconds. For scenarios with relative closing speeds of up to 300 m/s, this unknown offset may correspond to a position error on the order of 1 meter, which could make the difference between successful and unsuccessful operation of active countermeasures.

Additionally, in certain cases, it may be advantageous to provide an image of an approaching threat for the purpose of classifying the threat and optimizing the operation of active countermeasures according to the type of threat. However, derivation of an image from event camera output is a relatively slow and computationally-heavy process, which may not be feasible to incorporate into a system with limited computational power at a rate that is compatible with real-time high-speed usage scenarios. Certain embodiments of the present invention provide solutions to one or more of the above challenges.

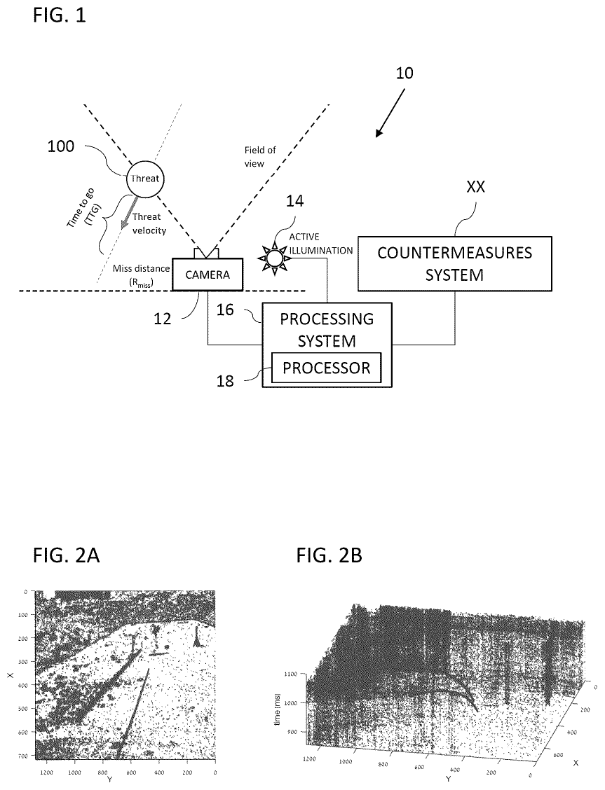

Referring now to the drawings, FIG. 1 illustrates schematically a system, generally designated 10, according to an embodiment of the present invention, for synchronizing a response to an approaching object (typically referred to as a “threat”) 100. In general terms, system 10 includes an event camera 12 deployed to monitor a field of view and, in certain embodiments, a pulsed active illumination system 14 deployed to deliver pulses of illumination towards at least part of the field of view. A processing system 16, including at least one processor 18, is associated with event camera 12 and the pulsed active illumination system 14. According to an embodiment of the invention, the processing system 16 is configured to:
monitor events from event camera 12 to detect a looming object (or “threat”);
track the looming object and process events associated with the looming object to determine motion parameters indicative of a remaining time until the object “passes” the camera position and a passing distance of that passing from the camera;
receive events from the event camera occurring within a defined time period after actuation of a pulse of the illumination towards the looming object; and
derive from the events occurring after actuation of the pulse a correction for a delay in the motion parameters.

According to a further aspect of the invention, applicable either with or without the use of a pulsed active illumination system 14, processing system 16 is configured, in addition to determining motion parameters of a looming object, to:
process events associated with the looming object to derive a selective image of the looming object; and
apply an image classifier to the selective image in order to determine a type of threat.

The structure and function of these aspects of the present invention will be better understood from the following detailed description.

The various aspects of the present invention provide a system that can operate continuously to detect threats in real time through use of an electro-optical sensor without requiring additional sensor modalities. The underlying principle of the approach of the present invention is to employ an event camera, which offers fast response times, good performance in a wide range of illumination conditions, low energy consumption and compact data transmission. The events from the event camera are processed using combined triangulation and “looming” calculations to determine the motion parameters of an approaching threat. Rapid response times are ensured by:
a. The inherent low latencies of the selected sensor itself.
b. An optical design that is adapted to the usage scenario.
c. Algorithm architecture that enables low computational delays, typically by allowing any computationally-heavy processes to run in parallel to the main tracking and proximity calculations.
d. A customized computer system.

Additionally, according to certain implementations of the present invention, potential errors due to latency jitter are detected and corrected by use of pulses of illumination. Each of these features will be further detailed below.

The various parameters of the optical system, and the requirements from the processing system, are implemented according to the requirements from the system. For smaller and faster approaching objects, it will be necessary to work with a narrower field-of-view sensor, and more stringent requirements are imposed on the processing speed and activation response-time of the pulsed illumination system (as well as requiring a higher luminance of the light source). Conversely, if the object is slower and larger, the field of view can be increased, thereby keeping the object in the field of view until a later stage of flight, and thus achieve higher accuracy of evaluating the threat's passing time, as well as better dealing with trajectories that include non-uniform acceleration.

Structurally, as described above, system 10 includes electro-optical sensor (event camera) 12, a light source 14 with switching capability, and a processing system 16. The sensor is directed towards a region from which a threat is expected to come, either by actively pointing by active gimbal control according to external information about an approaching threat, or by permanently pointing in the relevant direction relative to a fixed or mobile platform. The sensor operates continuously, and does not require any external data regarding timing of arrival of a threat. The pointing direction does not need to be precise so long as the field of view covers the region from which a threat may originate, and leaves room around the source pixel for the threat to grow (“loom”) within the field of view as it approaches.

Event camera 12 may be any commercially-available event camera, such as DAVIS346 commercially available from iniVation AG (CH) or SilkyEvCam commercially available from CenturyArks Co. Ltd. (JP). The event camera may be chosen to be sensitive to visible light and/or near infrared, or may be a thermal infrared event camera, depending on the application.

The field of view (FOV) of the sensor is typically wide, and in certain typical applications, may be in the range of 90-120 degrees, although smaller FOVs or larger FOVs, in certain cases even extending up to a 360-degree omnidirectional FOV, may be suitable for certain applications. In general, a large field of view facilitates accurate time estimation, since the algorithm is based on the apparent growth of the looming object in the field of view, requiring a large field of view around the initial detection direction so as to delay the point at which the threat expands beyond the limits of the FOV. However, a large FOV may also delay initial detection of a threat until the looming object triggers events in a sufficient number of pixels to allow detection. The size of the field of view to be used for a given application is derived from several parameters, including the speed and acceleration characteristic of the expected threats, the range of miss-distances of the threat from the sensor to which the system is required to cater, and the accuracy required from the system for determining the passing time. Where the required performance parameters dictate a FOV which is less than the total FOV to be covered by the system, multiple sensors may be deployed to provide coverage greater than that offered by a single sensor. Such multiple sensors (not shown) may share a common processing system, or may be implemented as fully-or partially-autonomous systems, each with its own processing system.

In some cases, the event sensor may be used for more than one purpose. In such cases, the object tracking processing as detailed below may occur continuously, in parallel to other functions. Alternatively, the object tracking processing may be actuated selectively by a distinct threat-detection mode based on the sensor output, or by an external alert based on another sensor.

The active illumination light source 14 is preferably deployed close to the sensor, points in the same direction, and preferably illuminates the entire field of view seen by the camera. The spectral range of the source corresponds to a range that the camera senses with high efficiency, and in some preferred implementations, in the near infrared range (e.g., 800-950 nm). This light source facilitates nighttime operation of the system, but its primary purpose, equally relevant by day, is to allow real-time correction of inaccuracies in the estimated motion parameters resulting from the latency jitter of the sensor.

The unknown delay in reporting events can vary from as little as a few microseconds up to a few milliseconds, depending on the contrast of the target with respect to the background, and the intensity of the background lighting. The delay may also vary between sensors, even of the same model. Thus, despite tracking of a target being successfully performed, the system would normally have a range of uncertainty about the true current position of the target, and thus also its passing-time, of up to 3 milliseconds. According to one aspect of the present invention, this uncertainty is calibrated and corrected by use of an illumination pulse. Particularly for a relatively close target, a large group of positive events (or a group of negative events, in the case of an “off” pulse) generated during the sensor's period of uncertainty (e.g., a 3-millisecond period) after the pulse can be reliably attributed to the start of the illumination pulse, thereby providing a reliable indication of the true position of the threat at the moment of the pulse. This true position can be compared to the results of the standard tracking process to identify a tracking-delay offset, which can then be used to extrapolate the true current position, and to calculate more accurately the passing-time of the object.

Typically, a positive “on” flash is used during daylight hours, when the illumination system is normally off, whereas an “off” flash (or “dark pulse”), where the source is quickly turned off and on, may be used at night, when the illumination system is otherwise activated to facilitate tracking. The timing of the flash of light or darkness is synchronized by the processing system, which then activates an event image processing algorithm that may briefly take priority over the regular motion tracking algorithm, for a period of several milliseconds, and performs a process of “synchronizing” the location of the threat with respect to an internal clock. The moment of the flash in the event image can be identified according to an immediate increase in the number of events reported by the sensor (and with a clear polarization of “on” and “off”), and by processing the image of these events, the silhouette of the threat and its position in space at the moment of the flash can readily be determined. Comparison of this position relative to the results of the regular processing make it possible to cancel out the offset resulting from the delay of the detector, and make corresponding corrections to the results of the passing-time evaluation.

The optimal timing for activating the flash is adjusted according to the particular scenario. On one hand, it should be sufficiently early that the object has not yet left the camera's field of view, while also being late enough to get a clear image of the threat in the field of view (i.e., that the threat will occupy a large enough number of pixels to clearly identify its outline). The duration of the flash should also be adapted to the scenario: long enough to deliver enough light to generate a large number of events by illumination reflecting from the surface of the threat, while being sufficiently short not to disrupt the ongoing tracking process significantly.

By way of one non-limiting example, a flash that lasts for 3 milliseconds allows a clear separation between “on” events and “off” events, since the pixel response frequency is always faster than this time period. In the time frame of 3 ms a threat approaching at 300 m/s will move about 90 cm. It would be advantageous to activate the illumination flash a few meters before the threat exits the field of view. In this case, activation of the flash when the target is about 10 meters before leaving the field-of-view may be ideal. This allows continued tracking after the flash while benefiting from a correction derived from the flash-induced events. There is a “blind” range of roughly another 2.5 ms after the flash due to the uncertainty of the delay the pixel, equivalent to another 75 cm. A range of 10 m before exiting the field of view is a range at which the target is very close to the edge of the field, so it is relatively large and its structure can be identified, but we also have more than 25 ms left before the threat leaves the FOV, thus enabling final corrections to the passing-time calculations based on further object tracking, but with the benefit of the tracking delay correction.

Another option for synchronization using switched illumination employs cyclic activation and deactivation of the lighting source, without modifying pulse timing to the path of a specific sensed threat. According to this approach, at each “off” or “on” time-point, a clear pattern of events over the area of the threat are obtained, which can be used for real-time synchronization of the tracking algorithm, without the need for triggering a proactive flash as part of the flow of the algorithm. A disadvantage of this approach is that, at each time of switching on or off of the illumination, the tracking algorithm is momentarily “blinded” by the excess number of events resulting from switching of the light source rather than from the movement of the threat, thereby preventing successful evaluation of the threat's expansion rate for deriving the passing time. In order to allow effective tracking between these flashes, the flash frequency must be kept sufficiently low.

By way of example, if a switching frequency of 20 Hz is used for switching the light source, this leaves a period of 50 ms between switching on and off (or between momentary single flashes). Allowing for an uncertainty of the pixel delay on the order of ±2.5 ms, there remains a period of about 45 ms to track and re-evaluate the threat path without interruptions of events created by the light switching. This period of time allows continuous evaluation of a 13.5 m approach of a threat moving at 300 m/s due to events from the threat only, interspaced with 1.5 m of “blindness” due to source switching for the purpose of pixel delay-time synchronization.

Where there is concern about use of active illumination for security reasons, for example, during covert work, it may be preferred to activate the illumination selectively, especially at night, only when a threat is thought to be approaching or is likely to be encountered. In this case, sensing of an approaching threat can be achieved through the system itself (e.g., by sensing a launch flash using the event camera) or by an external threat detection system (e.g., a radar system, information from nearby vehicles, or some other external detection system).

The system for synchronizing a response to an approaching object effectively provides what may be described as enhanced “proximity sensor” functionality, with predictive capabilities well before arrival of the object, and preferably providing all of the motion parameters mentioned herein. The processing required to provide the “proximity sensor” functionality described herein by use of an event camera typically imposes a relatively low computational load compared to image-based proximity sensors, at least in part due to the fact that neither object edge detection processing nor classification processes are required for the tracking and proximity calculations. Even without the use of active illumination, it is typically possible to achieve reasonable accuracy in the timing of the passing time estimation, typically to a precision of up to about 1 millisecond, and with the addition of processing based on a switched lighting source, accuracy can be improved by an order of magnitude, typically reaching a precision of about 100 microseconds. Classification of the threat is typically performed only after it has been identified as a threat, by selective reconstruction of an image of only the threat itself based on events associated with the threat. Furthermore, the event camera may be used simultaneously for additional tasks, such as threat classification, observation, launch detection, situational awareness, etc., without compromising the ability to perform passing time evaluation in real time.

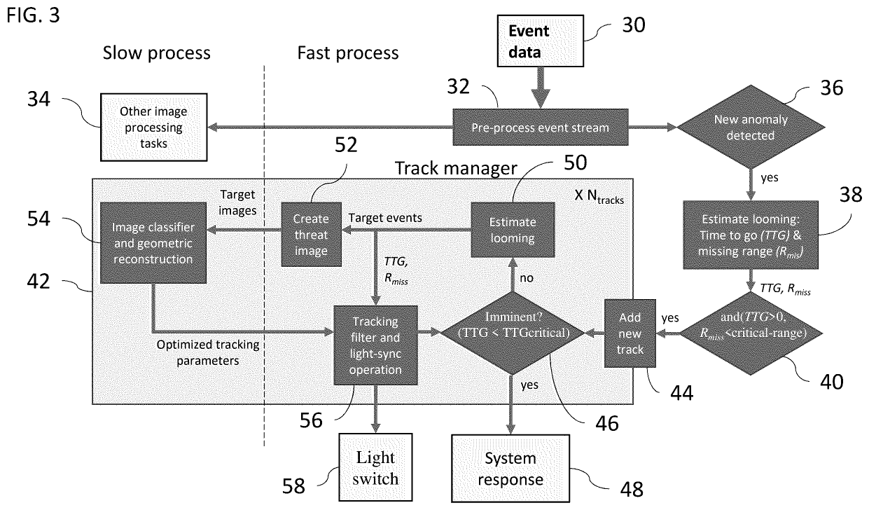

Turning now to FIG. 3, this illustrates one non-limiting example of a flow architecture for an algorithm, performed by corresponding modules of processing system 16, which may be implemented as software modules executed on generic processors, dedicated hardware such as ASICs, or any combination of hardware and software, as is known in the art, to implement an embodiment of the present invention. The event data (box 30) is preferably delivered continuously to a preprocessing block 32, where the data is preferably processed to perform pre-filtering of noise. Filtering of noise from an event stream of an event camera is known in the art, and typically includes one or more of: removing uncorrelated events, correcting threshold mismatch, and removing over-active pixel events, all as is known in the art. Optionally, a correction is also performed at this point of event location values on the detector plane to an angular position in the landscape according to camera calibration data. The camera data, with or without this pre-processing, may be transferred for use in other tasks (box 34), which may occur continuously at least while the proximity sensing process is in a “standby mode.” These other tasks may be one or more of a wide range of tasks according to the needs of the platform, which may relate to navigation, orientation, mapping, line of sight corrections, and other functions, based on information from the camera optionally in combination with outputs from additional sensors. Entering the “proximity sensor” mode typically occurs on the basis on one or more of the following: autonomous activation of the proximity sensor mode in the event that an area of the camera's image has multiple changes (events) indicative of a potential threat coming from a certain direction; and/or the sensor can be switched into proximity sensor mode by an alert based on another sensor. These options are represented schematically in FIG. 3 by box 36. In the case of autonomous activation, this module monitors the event stream to identify sequences of events which have characteristics of expansion (looming) of an object within the field of view. Then, at block 38, the algorithm monitors progression of the looming expansion with time, combined with tracking of the object, and estimates the expected passing time (labeled “Time-to-go” or TTG) and the passing distance within the sensor plane (labeled Rₘᵢₛₛ, as “missing range”), which is preferably a vector quantity including also the passing direction. The “passing distance” and “passing direction” are typically defined in terms of the position of event camera 12 so that, for example, if the event camera is mounted at a known position near the top-middle of a vehicle with known length and height, the calculated “passing distance” and “passing direction” allow the system to determine whether an incoming threat it predicted to hit the vehicle or to miss, and/or in what direction any directional countermeasures should be operated. Then, at block 40, according to the relevance of the data as indicating an approaching threat (TTG>0) and a likelihood of a hit (Rₘᵢₛₛ<critical range), the approaching object is added to the track manager 42 as a new track (block 44).

Track manager 42 can preferably process multiple tracks simultaneously, either where more than one threat is present within a single sensor FOV, or in cases where multiple sensors cover separate FOVs. For each track, the track manager checks for whether the arrival of the threat is imminent (block 46), illustrated here as a condition TTG<TTG_{critical}). TTG_{critical} in this context may be determined by the time required to actuate the system response 48 (such as active countermeasures), or by the object at least partially leaving the sensor FOV so that further updating of the TTG will no longer be possible. Once this critical time has been reached, the most recent estimates for passing time (TTG) and passing distance/direction (Rₘᵢₛₛ) are transferred for implementing the system response 48.

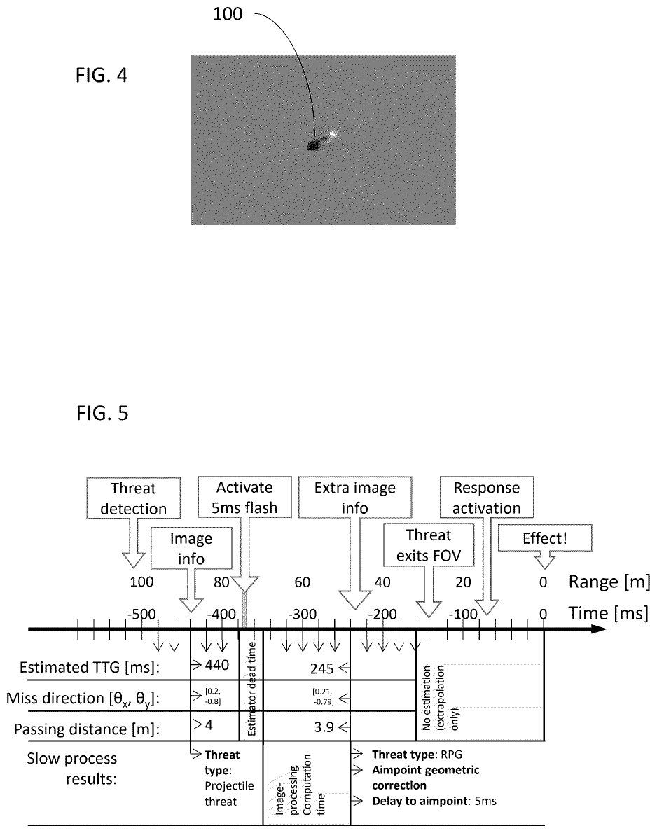

If the critical time has not yet been reached, the track manager continues the tracking process (block 50), generating updated estimates of TTG and Rₘᵢₛₛ in a manner similar to the processing of block 38. In addition to estimation of the motion parameters, this process also identifies which events from the stream of events correspond to the same features of the target at successive times/positions in the field of view. This data can advantageously be used (block 52) to build an image of the target. Construction of this image follows general principles that are known for generating images from streams of events from an event camera, primarily by integrating changes corresponding to a particular feature over a particular time window. However, unlike conventional techniques for generating images from an event camera, the image reconstruction process is performed selectively only on areas associated with the target, thereby reducing the complexity of the processing to a streamline process which can be performed rapidly in real-time. In addition, as these events relate to an object with adheres to a certain estimated looming motion, it is possible to reliably reconstruct an image of the object with minimal blurring. An example of a target image, derived from the event camera data of FIGS. 2A and 2B, is illustrated in FIG. 4. The target image is then preferably transferred to an image classifier 54, which provides an indication of the nature of the threat and its orientation, which may then be used both to enhance/verify the tracking parameters and/or to optimize operation of the countermeasures system response 48. The processing of image classifier 54 is typically significantly slower than the other tracking-related processes of track manager 42, typically taking several calculation cycles, but this processing is preferably performed in parallel to the primary tracking process and does not hinder that process. The processing may be performed using different tools, possibly including artificial intelligence to resolve the classification and body posture of the threat. The additional information from image classifier 54 is provided as it becomes available, and at least prior to operation of the system response 48. This additional information can also be used to enhance the tracking process, for example, facilitating selection of a particular point on the threat body that is used by the tracking algorithm for the passing time estimation.

Additionally, or alternatively, tracking filter and light-sync operation module 56 implements the synchronization process described in detail above, operating a light switch 58 to actuate flashing of active illumination light source 14 to generate pulses, either timed in relation to the trajectile path or at a fixed frequency, all according to the various schemes described above, thereby briefly interrupting the regular tracking so as to determine any time-offset in the tracking process. This offset is then fed back as a correction to the tracking parameters and the tracking continues until the imminency condition of block 46 is satisfied.

The specific architecture of the flow in FIG. 3 is given only as a single possible illustration, but it will be clear that the specific sequence of the operations is not to the exclusion of additional possibilities, and that various additional processes or functions may be added, examples of which will be discussed below.

FIG. 5 illustrates an exemplary timeline for output of the estimated passing time (TTG), miss direction (θₓ, θ_{y}) and passing distance Rₘᵢₛₛ derived from a data stream according to the teachings of an embodiment of the present invention. The successive calculations in this non-limiting example, represented by downward arrows on the timeline, are each based on events arriving within a “time slice” of roughly 20 milliseconds, but the duration of the time slice is itself a parameter which may be dynamically varied, for example, according to the rate at which event data is accumulating. The estimations typically become successively more precise as the object occupies a successively larger region of the FOV, and a larger number of events are generated by motion of the growing object in each successive time slice.

In the example illustrated here, initial detection of a threat occurs at a range of about 100 meters, and calculations immediately start regarding the passing time, miss direction and passing distance. Initial estimation of the threat event rate and trajectory persistence allow the processing unit to verify this event train might be a “real threat” of a “projectile threat” type.

Roughly 60 ms later, a flash of 5 milliseconds duration is generated, to allow collection of synchronizing data. This event temporarily blinds the background estimator process, but provides the image processing unit with events that are regarded as “image info”. These events, after the required computation time taken here as 100 ms duration, provide a correction to the estimated passing time due to event latency, miss direction and passing distance and detailed classification of the threat type. These computations are performed in parallel to the resumed updating of the motion parameters (passing time, miss direction and passing distance) based on ongoing tracking from the no-flash event data stream. Classification of the threat, when available, may enable corresponding selection of an aimpoint and a timing correction for the passing time of that aimpoint, to allow optimal actuation of a response (countermeasures).

The tracking algorithms may output various data according to the particular application. The underlying processing is based on assessing the rate and direction of enlargement of the object in the FOV as it approaches the camera plane, which can be used to generate an output to the management software of one or more of:
The passing time, typically in the format of the remaining time until the object crosses the plane of the camera.
The direction of the object velocity in space relative to the camera and/or the miss distance of the object from the camera when it crosses the plane of the camera, or in some cases, when it passes its closest point to the camera.

These outputs may be used by track manager 42 in additional processes which span multiple cycles of the tracking algorithm. For example, assessment of a given threat (or multiple threats, if required) may continue over a longer period of time than a single calculation cycle, and the output of the system may be optimized based on the results of successive cycles. Furthermore, by tracking changes between successive calculations, it is possible to assess the motion of threats with more complex dynamics, such as threats with maneuverability. The track manager 42 can thereby provide highly reliable information on an approaching threat which requires a system response.

Given additional data of the classification of the threat (for example, information about its physical dimensions) or of the magnitude of the closing speed (for example, from another sensor such as a radar system), it is also possible to estimate the distance at any given moment of the threat in relation to the sensor.

The system uses the output data for various purposes as needed, for example, for timing active interception mechanisms, evasion or for timing initiation of a warhead.

One optional addition to the system as described thus far is to provide a mechanism for generating momentary displacement of the event camera, typically when a suspected threat is first detected. When performed in a controlled and rapid manner, this motion may provide one or more of the following advantages:
Enable detection of threats at longer ranges, and with higher sensitivity through generating additional events corresponding to structures in the scene, in some cases even where those structures are of sub-pixel dimensions.
Improve the accuracy of the passing time estimation, for example, by providing sufficient information for triangulation processing.
Enable rough estimating of the range for the threat, even without additional data about the threat.
Facilitate generation of an image of the entire FOV even when there is no change in the landscape.

A further optional modification of the system may be useful in cases where the event camera sensor is to be used for both narrow FOV purposes (for purposes unrelated to the function of the sensor as a proximity sensor) and for wide FOV purposes (including but not limited to the proximity-sensor functionality of the present invention). In order to optimize the sensor for performing both functions, the optical components of the sensor can be designed with “controlled distortion.” This approach is primarily suited to applications in which the sensor is directed so that the center of the field is directed towards a location from which the threat will originate.

“Controlled distortion” refers to a type of optical design in which the spatial coverage of each pixel (IFOV) varies according to its position on the detector. In this case, the IFOV in the center of the field of view is made smaller than the IFOV at the periphery, resulting in a “magnifying glass” effect in the center of the field from where the threat comes. On the one hand, this offers more detailed (higher resolution) data about the threat and/or collection of other data of interest at long ranges, thereby allowing detection of the threat with higher sensitivity and possibly allowing classification of the threat at an earlier stage of its trajectory, while on the other hand, not sacrificing the size of the overall field of view, which is important for the precise calculation of the passing time in the final stages of the threat's progress towards the camera.

It will be appreciated that the above descriptions are intended only to serve as examples, and that many other embodiments are possible within the scope of the present invention as defined in the appended claims.

What is claimed is:

1. A system for synchronizing a response to an approaching object, the system comprising:
(a) an event camera deployed to monitor a field of view;
(b) an active illumination system deployed to deliver pulses of illumination towards at least part of said field of view; and
(c) a processing system associated with said event camera and said pulsed active illumination system, said processing system including at least one processor, said processing system configured to:
(i) monitor events from said event camera to detect a looming object, at
least some of the events originating from motion of the looming object while said active illumination system is in a steady state;
(ii) process the events associated with the looming object so as to track the looming object and to determine motion parameters for predicting an estimated passing time and passing distance from said event camera;
(iii) receive illumination-pulse-related events from said event camera occurring within a defined time period after an illumination transition associated with a pulse of said illumination towards the looming object; and
(iv) derive from said illumination-pulse-related events a correction to said motion parameters.

2. The system of claim 1, wherein said pulse of illumination is triggered during tracking of a looming object and synchronized as a function of an estimated time until the looming object will leave the event camera field of view.

3. The system of claim 1, wherein said pulse of illumination is one of a series of pulses of illumination triggered at a predefined intervals independent of tracking of a looming object.

4. The system of claim 1, wherein said pulsed active illumination system is non-illuminating except during said pulses.

5. The system of claim 1, wherein said pulsed active illumination system illuminates at least part of said field of view, and wherein said pulses are pulses of darkness during which the illumination is interrupted.

6. The system of claim 1, wherein said deriving includes determining from said illumination-pulse-related events a precise position of the looming object at the moment of said illumination transition, comparing said precise position to a position indicated by said tracking, and providing a correction to said tracking as a result of said comparison.

7. The system of claim 6, wherein said correction includes a time offset to compensate for an unknown time delay in events output by said event camera.

8. The system of claim 1, wherein said processing system is further configured to:
(a) process events associated with the looming object to derive a selective image of only a region of the field of view corresponding to the looming object; and
(b) apply an image classifier to the selective image in order to determine a type of threat.

9. The system of claim 1, wherein said processing system is further configured to output said passing time and said passing distance to an active countermeasures system.

10. The system of claim 1, wherein the system is mounted on an intercepting projectile, and wherein said processing system is further configured to output said passing time and said passing distance to a threat-destruction system.

11. A system for synchronizing a response to an approaching object, the system comprising:
(a) an event camera deployed to monitor a field of view; and
(b) a processing system associated with said event camera and including at least one processor, said processing system configured to:
(i) monitor events from said event camera to detect a looming object;
(ii) track the looming object and process events associated with the looming object to determine motion parameters indicative of a remaining time to passing and a passing distance from said event camera;
(iii) process events associated with the looming object to derive a selective image of only a region of the field of view corresponding to the looming object; and
(iv) apply an image classifier to the selective image in order to determine a type of threat.
